(19) United States
(12) Patent Application Publication
(10) Pub. No.: US 2013/0313838 A1
(43) Pub. Date: Nov. 28, 2013

(54) LINEAR MOTOR, LINEAR DYNAMO, RECIPROCATION-TYPE COMPRESSOR DRIVING SYSTEM THAT IS POWERED BY LINEAR MOTOR, AND CHARGE SYSTEM THAT USES LINEAR DYNAMO

(71) Applicant: NIPPON PISTON RING CO., LTD., Saitama-shi (JP)

(72) Inventors: Masafumi SAKAMOTO, Shimotsuga-gun (JP); Shigeyoshi SATO, Shimotsuga-gun (JP); Shunsuke TAKEGUCHI, Shimotsuga-gun (JP)

(73) Assignee: NIPPON PISTON RING CO., LTD., Saitama-shi (JP)

(21) Appl. No.: 13/902,484

(22) Filed: May 24, 2013

(30) Foreign Application Priority Data
May 25, 2012 (JP) 2012-119787

(51) Int. Cl. F03G 7/08; H02K 35/04; H02K 33/18

(52) U.S. Cl. CPC F03G 7/08; H02K 33/18; H02K 35/04
USPC 290/1 R; 310/12.16

(57) ABSTRACT

The disclosed is a linear motor which comprises an armature part including a coil, a field magnet part including a permanent magnet or an electromagnet, and a yoke part, in which the armature part is distributed in the field magnet part to excite the coil in the armature part, and which gives either the armature part or the field magnet part a rectilinear motion, wherein the armature part has a molded body in which the coil is covered with a magnetic substance, or has a structure in which a wall is formed on at least one of the internal circumference and the outer circumference of the coil with a magnetic cylindrical body.

### TECHNICAL FIELD

This invention relates to a linear motor and a linear dynamo, as well as a reciprocation-type compressor driving system and a charge system using them.

### BACKGROUND ART

There are a lot of usages for the electric motor and the dynamo that need a rectilinear motion. Particularly, the types in that the gyration with the rotation electric machine is mechanically converted into a rectilinear motion for instance, the rack & pinion and belt, etc., are large in number. However, there are a lot of cases where the miniaturization and the positional accuracy due to backlash of the gear, etc., become problems, when the gyration is mechanically converted into a rectilinear motion. In that case, the rectilinear motion type electric motor (hereinafter, it is referred to as “linear motor”.) is used.

As for the compressors, there are a reciprocating piston-cylinder type driven with a linear motor and a scroll type driven with a rotation motor. The former tends to generate a large vibration while it can achieve a high compression ratio, and the latter has reversed tendency. Thus, they have both merits and demerits, individually. However, in the case that highly effective is required for the compressor, the former is likely to be adopted, and thus, the usage of the linear motor is on the increase in recent years. As for these linear motors, the demand of downsizing has been also highly sought in the market. In addition, as for the linear motors, the demands of energy saving and high efficiency for the linear motor has been increased recently, as measures for controlling global warming. And, as for the linear dynamos, the high efficiency has been also desired because of the acute requirement for economical driving of vehicles. However, since the linear motors in the prior art are difficult to lessen their air-gaps, it has problems in terms of the high-torque and the high-efficiency.

The following Patent Literatures 1 and 2 are enumerated as relating prior arts.

### PRIOR ARTS' LITERATURE

### Patent Literature

(Patent Literature 1) JP 2008-222112 A
(Patent Literature 2) JP 2012-065525 A

### Summary of invention

### Problem to be Solved by the Invention

1) In accordance with Fleming's rule, the linear motor generates a driving force, and the linear dynamo generates an electric power. In order to improve these efficiencies, it is necessary to enlarge the amount of magnetic flux which interlinks to a coil by passing over the gap part in both cases. However, it is difficult for the linear type electric machine to reduce the gap between a mobile part and a stator as compared with the rotating machine. Thus, the reluctance in the gap part becomes large, and therefore, it is difficult to enlarge the amount of the magnetic flux which interlinks to the coil. The present invention aims to decrease the reluctance in the gap part of the linear type electric machine. Thereby, it is possible to improve the efficiency of the conventional linear type electric machine and to contribute to the power saving.

2) Moreover, the present invention indicates applications of a linear type electric machine that decreases the reluctance in the gap part.

### Means for Solving the Problems

By the following means, the present invention can be achieved.

### <First Means>

A linear motor which comprises an armature part including a coil, a field magnet part including a permanent magnet or an electromagnet, and a yoke part, in which the armature part is distributed in the field magnet part to excite the coil in the armature part, and which gives either the armature part or the field magnet part a rectilinear motion, wherein the armature part has a molded body in which the coil is covered with a magnetic substance, or has a structure in which a wall is formed on at least one of the internal circumference and the outer circumference of the coil with a magnetic cylindrical body.

### <Second Means>

The linear motor according to the above-mentioned first means, wherein at least one of the internal circumference and the outer circumference of the armature part has a concavo-convex shape, and a part facing the armature part has a concavo-convex shape which follows the concavo-convex shape of the armature part via a gap.

### <Third Means>

The linear motor according to the above-mentioned first means or the above-mentioned second means, wherein the permanent magnet or the electromagnet in the field magnet part is divided into p numbers of pieces, and the magnetic substance or the magnetic cylindrical body in the armature part is similarly divided into p numbers of pieces, wherein p represents a positive integer of two or more

### <Fourth Means>

A linear dynamo which comprises an armature part including a coil, a field magnet part including a permanent magnet or an electromagnet, and a yoke part, in which an electromotive force is generated in the coil of the armature part by a rectilinear repetition movement in at least one of the armature part and the field magnet part by giving an external force,

wherein the armature part has a molded body in which the coil is covered with a magnetic substance, or has a structure in which a wall is formed on at least one of the internal circumference and the outer circumference of the coil with a magnetic cylindrical body.

### <Fifth Means>

The linear dynamo according to the above-mentioned fourth means, wherein at least one of the internal circumference and the outer circumference of the armature part has a concavo-convex shape, and a part facing the armature part has a concavo-convex shape which follows the concavo-convex shape of the armature part via a gap.

### <Sixth Means>

The linear dynamo according to the above-mentioned fourth means or the above-mentioned fifth means, wherein the permanent magnet or the electromagnet in the field magnet part is divided into p numbers of pieces, and the magnetic substance or the magnetic cylindrical body in the armature part is similarly divided into p numbers of pieces, wherein p represents a positive integer of two or more

### <Seventh Means>

A reciprocation-type compressor drive system which is powered by the linear motor according to one of the above-mentioned first means to the above-mentioned third means.

### <Eighth Means>

A charge system in which the linear dynamo according to one of the above-mentioned fourth means to the above-mentioned sixth means is installed in a four-wheeled vehicle or two-wheeled motorcycle so as to be positioned coaxially with or in parallel with a shock absorber of the vehicle or the motorcycle, and the linear dynamo generates electricity by utilizing up-and-down jolting of the body of the vehicle or the motorcycle, and the electricity generated is charged into a battery.

### <Ninth Means>

A charge system in which the linear dynamo according to one of the above-mentioned fourth means to the above-mentioned sixth means is installed in a four-wheeled vehicle, a two-wheeled motorcycle, or a power-assisted bicycle so as to be positioned coaxially with or in parallel with a coil spring of a seat or a saddle of the vehicle, the motorcycle or the bicycle, and the linear dynamo generates electricity by utilizing up-and-down jolting of the body of the vehicle, the motorcycle or the bicycle, and the electricity generated is charged into a battery.

### <Tenth Means>

A charge system in which the linear dynamo according to one of the above-mentioned fourth means to the above-mentioned sixth means is installed on an internal combustion engine, and the linear dynamo generates electricity by utilizing vibration energy of the engine, and the electricity generated is charged into a battery.

### <Eleventh Means>

A charge system in which the linear dynamo according to one of the above-mentioned fourth means to the above-mentioned sixth means is installed in a ship or a float, and the linear dynamo generates electricity by utilizing kinetic energy due to dipping and heaving or swaying of the ship or the float, and the electricity generated is charged into a battery.

### Effect of Invention

1) The efficiency of the linear type electric machine is improved when the armature part in the linear motor or the linear dynamo has the molded body in which the coil is covered with a magnetic substance, or has the structure in which the wall is formed on at least one of the internal circumference and the outer circumference of the coil with the magnetic cylindrical body, and thereby, the effective length of the gap is decreased, and the reluctance in the gap part is decreased.
2) The efficiency of the linear type electric machine is improved when one of the internal circumference and the outer circumference of the armature part or both of them have a concavo-convex shape(s), and apart or parts facing the armature part have a concavo-convex shape which follows the concavo-convex shape(s) of the armature part via a gap, and thus, the opposed area between the stator and the mobile part can be increased as compared with that of the cylindrical type, and thereby, the reluctance in the gap part is decreased.
3) Since the linear motor according to the present invention generate a large driving force, it is suitable for driving the reciprocation-type compressor.
4) It becomes possible to charge auxiliary when the linear dynamo according to the present invention is installed in a four-wheeled vehicle or two-wheeled motorcycle so as to be positioned coaxially with or in parallel with a shock absorber of the vehicle or the motorcycle, and the linear dynamo generates electricity by utilizing up-and-down jolting of the body of the vehicle or the motorcycle.
5) It becomes possible to charge auxiliary when the linear dynamo according to the present invention is installed in a four-wheeled vehicle, a two-wheeled motorcycle, or a power-assisted bicycle so as to be positioned coaxially with or in parallel with a coil spring of a seat or a saddle of the vehicle, the motorcycle or the bicycle, and the linear dynamo generates electricity by utilizing up-and-down jolting of the body of the vehicle, the motorcycle or the bicycle.
6) When the linear dynamo according to the present invention is installed on an internal combustion engine, it becomes possible to generate electricity with the linear dynamo by utilizing vibration energy of the engine, and it also becomes possible to obtain a vibration suppression effect for the internal combustion engine.
7) When the linear dynamo according to the present invention is installed in a ship or a float, it becomes possible to generate wave activated power with the linear dynamo by utilizing the kinetic energy due to dipping and heaving or swaying of the ship or the float.

### BRIEF EXPLANATION OF DRAWINGS

FIG. 1 is a sectional view of an embodiment of the linear electric machine according to the present invention in the state of including axis.

FIG. 2 is a view of the linear electric machine shown in FIG. 1, viewing in a plane vertical to the axis.

FIG. 3 is a sectional view of another embodiment of the linear electric machine according to the present invention in the state of including axis.

FIG. 4 is a view of the linear electric machine shown in FIG. 3, viewing in a plane vertical to the axis.

FIG. 5 is a sectional view of further another embodiment of the linear electric machine according to the present invention in the state of including axis.

FIG. 6 is a view of the linear electric machine shown in FIG. 5, viewing in a plane vertical to the axis.

FIG. 7 is a sectional view of a still other embodiment of the linear electric machine according to the present invention in the state of including axis of a toroidal coil.

FIG. 8 is a view illustrating an embodiment where the present invention was applied to a shock absorber.

FIG. 9 is a view of a more other embodiment of the linear electric machine, viewing in a plane vertical to the axis.

FIG. 10 is a view of a still other embodiment of the linear electric machine, viewing in a plane vertical to the axis.

FIG. 11 is a sectional view of a linear electric machine according to the prior art's technology in the state of including axis.

### MODES FOR CARRYING OUT THE INVENTION

Now, the present invention will be described with reference to the drawings.

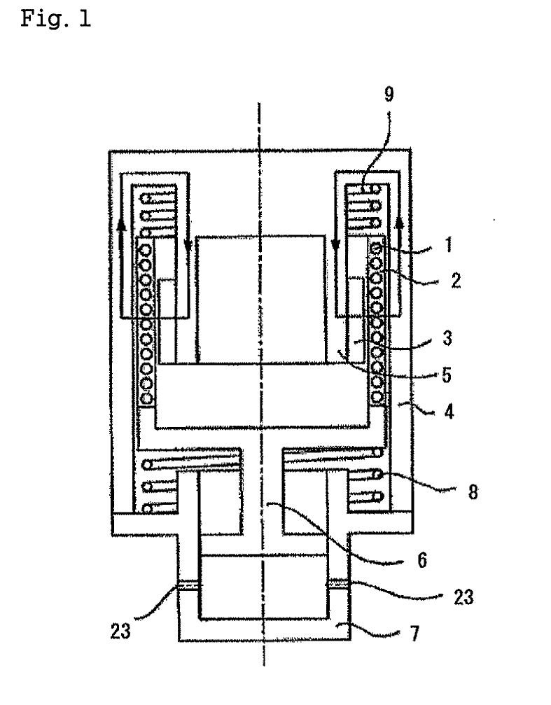

FIG. 1 is a sectional view of an embodiment of the present invention in the state of including a mobile axis.

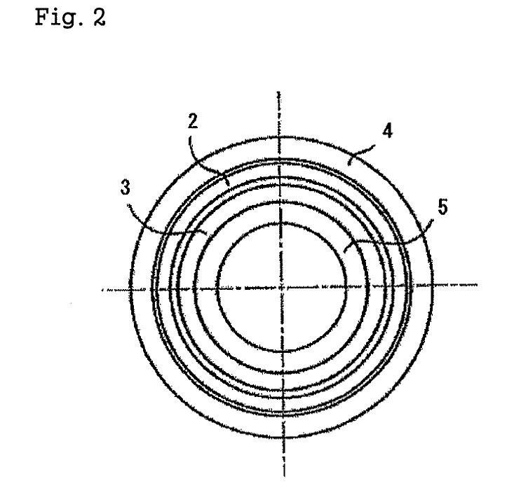

FIG. 2 is a view of the linear electric machine shown in FIG. 1, viewing from the mobile axial direction.

In FIG. 1 and FIG. 2, the numeral 1 denotes a coil that composes the armature part and that is a solenoid coil. The numeral 2 denotes a magnetic substance mobile part, which may be formed with a dust core, i.e., iron-powder compact magnetic core, which covers the coil 1. Alternatively, the magnetic substance mobile part may be formed with a resin which covers the coil 1 and which includes iron powder as a magnetic substance. The numeral 3 denotes a permanent magnet which forms the field magnet. The numeral 5 denotes a back yoke for the permanent magnet 3, and it is integrated with an outer circumference yoke 4 at the edge. The arrows shown in FIG. 1 indicates the flow of the magnetic flux of the permanent magnet 3 for the field magnet. The numeral 6 denotes a mobile part which is secured to the magnetic substance mobile part 2 which covers the coil 1 with the dust core or the resin. And the lower end of the mobile part 6 forms a piston for the compressor. The numeral 7 is a cylinder part of the compressor and in which a suction port and an exhaust port 23 are provided.

The numeral 8 and the numeral 9 denote coil springs, which are installed on both sides of the mobile part 6, and the spring constant thereof is chosen to produce resonance as much as possible between the amount of inertia and the movement reciprocating motion stroke's frequency of the mobile part 6. When giving an alternating current to the coil 1, a driving force arises in accordance with Fleming's left hand rule, and the mobile part 6 reciprocates as a linear motor. When giving an external force to the mobile part 6 in order to reciprocate, an electromotive force can be generated in the coil 1 in accordance with Fleming's right hand rule. In such situations, the driving force and the power generation efficiency is improved with reduction of the reluctance in the gap part. The reluctance in the gap part is in proportion to the gap length and in inverse proportion to the permeability of the opposite area and the mobile part. According to the present invention, the part represented by the numeral 2 exists in order to decrease the permeability in the gap part. That is, the armature part is formed as a molded body in which the coil 1 is covered with a magnetic substance, by adopting either means of covering the coil 1 with the dust core as the magnetic material or covering the coil 1 with the resin which includes iron powder.

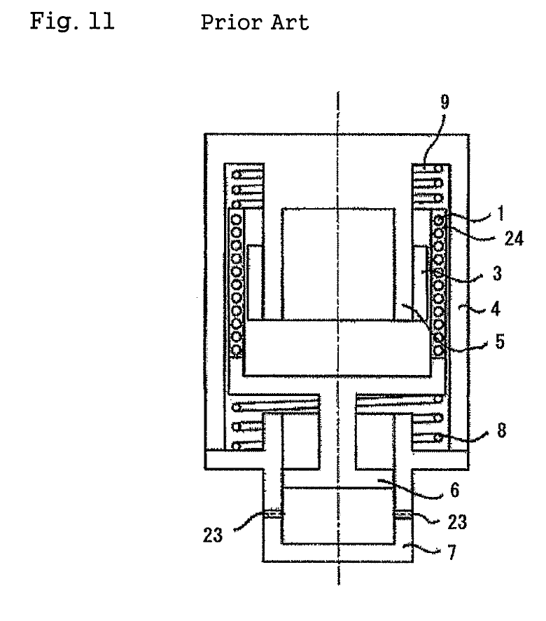

Now, the construction according to the present invention shown in FIG. 1 will be compared with the prior art shown in FIG. 11 for an explanation of the present invention.

FIG. 11 is a sectional view illustrating the construction of a linear electric machine according to the prior art's technology in the state of including axis of mobile part. In FIG. 11, the same numerals as shown in FIG. 1 are used with respect to the parts having the same functions and similar shapes.

In FIG. 11, a part different from FIG. 1 is a part represented by the numeral 24 to form a coil 1 that composes the armature part into a cylindrical body. The numeral 24 in FIG. 11 denotes a resin mold. Between the outer circumference part of the member represented by the numeral 3 and the inner circumference part of the member represented by the numeral 4, the copper wire of the coil that is a diamagnetic substance, the resin and air exist, and all of these have permeability in equal to that in a vacuum or less. With respect to the length of the gap between the outer circumference part of the member represented by the numeral 3 and the inner circumference part of the member represented by the numeral 4, the length, in which the width occupied by the air and the resin is added to the diameter of coil 1 so that coil 1 and the part represented by the numeral 24 can reciprocate, is necessary, and it is difficult to enlarge the intensity of the magnetic field in the gap part which is given by the permanent magnet 3. On the other hand, in the present invention shown as FIG. 1, because the armature part is formed as a molded body in which the coil 1 is covered with a magnetic substance, by using the member represented by the numeral 2 which is either means of covering the coil 1 with the dust core as the magnetic material or covering the coil 1 with the resin which includes iron powder, it gives birth to the effect that the gap becomes narrower in equivalence, and the magnetic flux density of the gap can be enhanced.

Herein, although the coil 1 in the magnetic substance mobile part 2 shown in FIG. 1 is embedded in the magnetic substance mobile part 2, the magnetic substance mobile part 2 according to the present invention does not necessarily exist in both of the outer circumference and the inner circumference of the coil, it may be provided in either circumference or may be provided only between conductors.

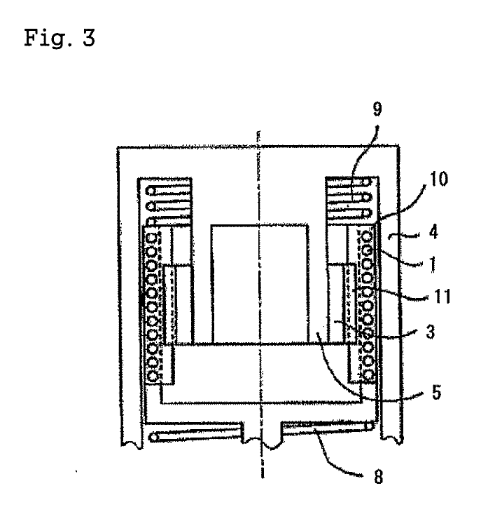

Next, embodiments according to the present invention in which the reluctance is reduced by enlarging the opposite area at the gap part will be explained with reference to FIGS. 3-6.

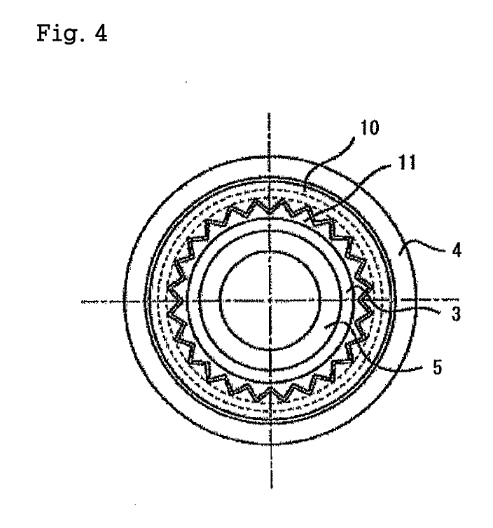

FIG. 3 is a view of another embodiment of the linear electric machine according to the present invention in the state of including a mobile axis. FIG. 4 is a view of the linear electric machine shown in FIG. 3, viewing from the mobile axial direction. In FIG. 3 and FIG. 4, the numeral 10 denotes a toothed magnetic substance mobile part, which is formed with a dust core which covers the coil 1 in order to compose the armature part. The internal circumference surface of the toothed magnetic substance mobile part shows a noncircular shape, and has a concavo-convex shape as shown in FIG. 4, more concretely, has an internal gear-like shape. In the thrust direction, it faces movably a member represented by the numeral 11, i.e., a so-called spur gear type magnet outer circumference tooth which has an external gear-like shape, and which is fixed on the outer circumference part of the permanent magnet 3, via a gap. Namely, one of the two members has a concavo-convex shape which follows the concavo-convex shape of the other member mutually. The permanent magnet 3 is magnetized in the same polarity in a radial direction. And, since the magnet outer circumference tooth 11, the gap of concavo-convex shape, the toothed magnetic substance mobile part in which the coil 1 is embedded, the yoke 4, and the yoke 5 at the other edge are mutually connected magnetically, a magnet magnetic flux comes to return to the permanent magnet 3 by way of these members sequentially, and a closed magnetic circuit is formed. Herein, since the opposite area at the gap can be increased by virtue of the concavo-convex shape, the reluctance can be reduced. Therefore, the interlinking magnetic flux can be increased, and a highly effective, linear electric machine can be realized. Herein, with respect to the internal circumference surface of the member represented by the numeral 10, and the external circumference surface of the member represented by the numeral 11, they are not limited to the gear-like shape shown in the figure, but they may be formed in rectangle tooth-like shape, trapezoidal tooth-like shape, wave-like shape, etc, as far as they shows a noncircular shape and they face each other via a gap.

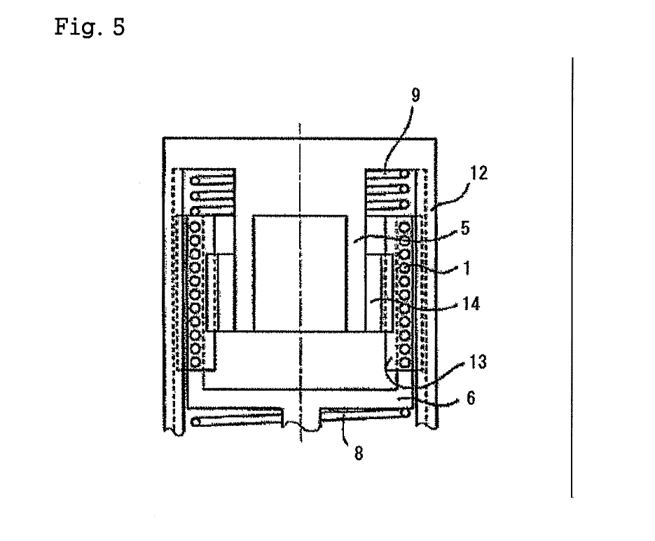

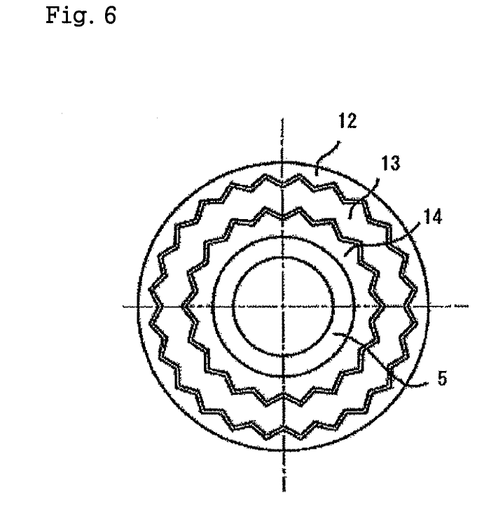

FIG. 5 is a view of further another embodiment of the linear electric machine according to the present invention in the state of including the mobile axis. FIG. 6 is a view of the linear electric machine shown in FIG. 5, viewing from the mobile axial direction. From FIG. 6, it can be understood that the internal circumference surface and the external circumference surface of a toothed magnetic substance mobile part 13 have a gear shape individually and which are opposed individually to a corresponding shape via a gap. A toothed yoke 12 is that has tooth at internal circumference surface thereof. Although this yoke can be constituted by layering silicon steel plates in the direction of the mobile axis, the material availability becomes bad in such a layering. Because the material at the inner parts should be wasted on forming the inner hole. On the other hand, according to the dust core method, it is possible to form such a shape by adding a suitable amount of a material for preventing eddy currents, such as silicon or the like, to an iron powder, and casting the resultant mixture material into a die, pressing the cast material and thereafter heat-treating it. Therefore, the dust core method is suitable for manufacturing such a shape at a low cost.

A toothed permanent magnet 14 is magnetized in the same polarity in a radial direction. And, since the gap of concavo-convex shape, the toothed magnetic substance mobile part 13, the toothed yoke 12, and the yoke 5 at the other edge are mutually connected magnetically, a magnet magnetic flux comes to return to the permanent magnet 14 byway of these members sequentially, and a closed magnetic circuit is formed. Herein, since the opposite area at the gap can be increased by virtue of the concavo-convex shape, the reluctance can be reduced. Herein, the toothed permanent magnet 14 may be constituted by fixing a toothed yoke 12 on the outer circumference part of the permanent magnet 3 as shown in FIGS. 3 and 4.

In this embodiment, as in the case of the embodiment shown in FIGS. 3 and 4, the concavo-convex shapes are not limited to the gear-like shape shown in the figure, but they may be formed in rectangle tooth-like shape, etc, as far as they shows a noncircular shape and they face to an individually corresponding shape via a gap. In this embodiment, since the opposite area at the gap can be increased more as compared with the embodiment shown in FIGS. 3 and 4, the reluctance can be reduced lesser. Therefore, the interlinking magnetic flux can be increased, and a highly effective, linear electric machine can be realized. In this case, as a thrust shaft bearing for the mobile part, the one which has a function for preventing rolling may be applied, optionally.

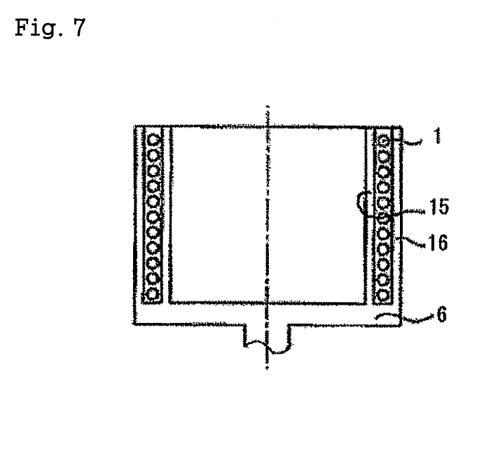

The embodiment shown in FIG. 7 is the one in which the coil 1 is interposed between magnetic cylindrical bodies 15 and 16, instead of putting the magnetic substance powder between the coil 1. It is possible to shape the internal circumference surface of the magnetic cylindrical body 15 and the outer circumference surface of the magnetic cylindrical body 16 as a noncircular shape individually, and they face to an individually corresponding shape via a gap, although such a modification does not shown in any figure. In this embodiment, the reluctance at the gap can be reduced as compared with the case of the prior art's technology shown in FIG. 11, although the reluctance at the gap becomes slightly larger than that of the embodiment shown in FIG. 5, to the extent that the magnetic substance powder is not put in the space between the coil 1. The magnetic cylindrical bodies 15 and 16 may be integrated with each other by a thin edge 6. Herein, the reason why the edge 6 is made thin is that the magnetic flux interlinking with the coil becomes lesser when the edge 6 is made thick. When making the integration, the reluctance at the gap part can be decreased as compared with the case of the prior art's technology as shown in FIG. 11, even in case of only one of the member represented by the numeral 15 and the member represented by the numeral 16 is formed as the magnetic body. In addition, in the case that only the member represented by the numeral 15 is formed as the magnetic body, the member 15 may be used as a magnetic frame for winding the coil 1, and thereby, the circularity of the cylindrical shape part of the coil can be improved.

Next, more other embodiments of the present invention will be explained. Although the permanent magnets 13 shown in

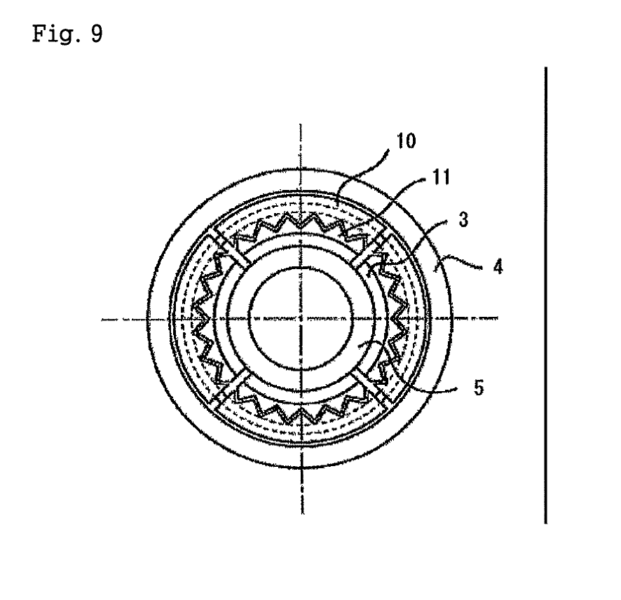

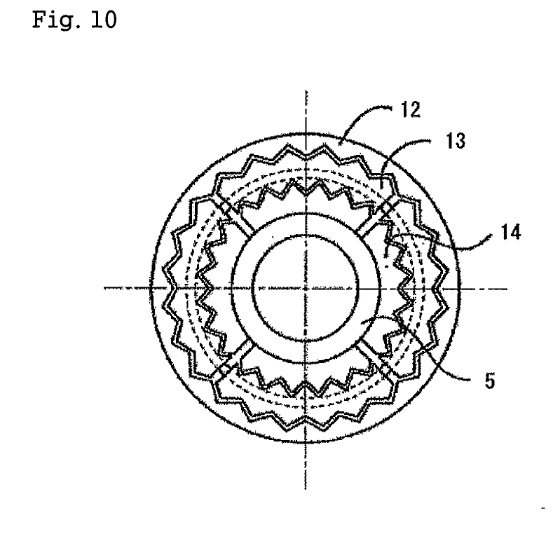

FIGS. 1-6 have a cylindrical shape, the permanent magnet is not limited to such a shape. For instance, the field magnet part may be constituted by using four numbers of segments each having a circular arc shape, and magnetizing the segments in the same polarity in the thickness direction, that is, in the radial direction, and arranging four numbers of the permanent magnet segments into a cylindrical shape. When the permanent magnet thus formed is applied into the embodiment shown in FIGS. 3 and 4, FIG. 4 is modified as shown in FIG. 9. In FIG. 9, with respect to parts or members having the same function with the corresponding parts or members shown in FIG. 3 and FIG. 4, the same numerals as shown in FIGS. 3 and 4 are given to them. In FIG. 9, four numbers of the permanent magnets 3 are magnetized in the same polarity in a radial direction. And, since the magnet outer circumference tooth 11 which is made of magnetic substance, the gap of concavo-convex shape, the toothed magnetic substance mobile part 10, the yoke 4, and the yoke 5 at the other edge are mutually connected magnetically, a magnet magnetic flux comes to return to the permanent magnets 3 by way of these members sequentially, and a closed magnetic circuit is formed. Herein, since the opposite area at the gap can be increased by virtue of the concavo-convex shape, the reluctance can be reduced. In addition, since divided segments constitute the permanent magnets 3, the toothed magnet substance mobile part 10 can hardly cause rolling behavior. Therefore, an effect that the function for preventing rolling is not necessarily needed for the thrust shaft bearing for the mobile part is obtained. Likewise, when the permanent magnet thus formed is applied into the embodiment shown in FIGS. 5 and 6, FIG. 6 is modified as shown in FIG. 10. In FIG. 10, with respect to parts or members having the same function with the corresponding parts or members shown in FIG. 5 and FIG. 6, the same numerals as shown in FIGS. 5 and 6 are given to them. In FIG. 10, four numbers of the permanent magnets 14 are magnetized in the same polarity in a radial direction. And, since the gap of concavo-convex shape, the toothed magnetic substance mobile part 13, the toothed yoke 12, and the yoke 5 at the other edge are mutually connected magnetically, a magnet magnetic flux comes to return to the toothed permanent magnets 14 by way of these members sequentially, and a closed magnetic circuit is formed. As in the case of the embodiment shown FIG. 9, since the opposite area at the gap can be increased by virtue of the concavo-convex shape, the reluctance can be reduced. In addition, the toothed magnet substance mobile part 10 can hardly cause rolling behavior. Herein, as the number for dividing permanent magnet or the like, it is only required to be an integer p of two or more. FIG. 9 and FIG. 10 indicate the case of p=4.

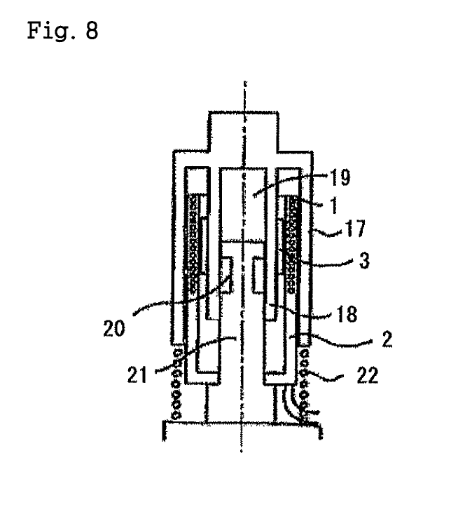

FIG. 8 shows another embodiment, wherein a linear dynamo and a shock absorber are utilized in combination. The numeral 17 denotes an inner yoke, and the numeral 18 denotes an outer yoke, and they are integrated with each other at the edge to form a magnetic path for the magnetic flux of the permanent magnet 3. The numeral 1 denotes a coil, and the coil is embedded in the magnetic substance mobile part 2 as in the case of the embodiment shown in FIG. 1. Then, the part represented by the numeral 2 is immobilized to a piston 21 of the shock absorber, and is able to reciprocate rectilinearly along with the piston 21. The edge of the member represented by the numeral 21 forms spaces represented by the numerals 19 and 20 with a cylinder as the interior of the member represented by the numeral 18. The space 19 and the space 20 are filled with oil. When the piston represented by the numeral 21 moves, the movement of the oil between the space 19 and the space 20 occurs, and the viscous resistance caused by the oil movement gives damping. The numeral 22 denotes a coil spring loaded between the member 17 and the member 21.

When the embodiment as shown in FIG. 8 is downsized and applied to between the axle shaft and the body of a motor vehicle or motorcycle, it is possible to resurrect up-and-down jolting on driving of the motor vehicle or motorcycle as electric energy. Further, when such a linear dynamo is installed in a motor vehicle so as to be positioned between springs or coaxially with a spring of a seat of the motor vehicle, or installed in a saddle of a motorcycle, or installed in a saddle of a power-assisted bicycle, the linear dynamo is also utilized for taking out differences in up-and-down vibration of between a man and the vehicle body on driving as electric energy.

In addition, when the spring constant is weakened so as to produce resonance with the dipping and heaving or the like of a ship or a float, the frequency of the dipping and heaving or the like being low relatively, and the linear dynamo is installed in the ship or the float, the energy of the wave can be converted into electric energy.

In general, the wave power can be rather used in bad weather conditions, while the photovoltaic power generation cannot be used at night or in rain condition.

Next, the differences between the present invention and two Patent Literatures quoted as prior arts will be explained. In FIG. 1 of Patent Literature 1, a linear generator is used between a wheel and a car body. Moreover, in FIG. 7 and FIG. 8, the construction of the linear generator is disclosed. However, it is clear that the disclosed linear generator is not the one to aim at highly effective like the present invention, and thus, it is clear that the linear generator disclosed in

Patent Literature 1 is different from the one according to the present invention. In FIG. 1, etc., of Patent Literature 2, the construction of another linear generator is disclosed. However, it is clear that the disclosed linear generator disclosed in Patent Literature 2 is essentially different from the one according to the present invention to aim at highly effective.

### INDUSTRIAL UTILITY

The linear electric machine according to the present invention can utilize as mentioned above, and is suitable for attaining a high torque and attaining highly effective, and is extremely practicable. Therefore, a great contribution is expected industrially.

### EXPLANATION OF NUMERALS

1 coil
2 magnetic substance mobile part
3 permanent magnet
4, 5, 17, 18 yoke
6 mobile part
7 cylinder
8, 9, 22, coil spring
10, 13, toothed magnetic substance mobile part
11 magnet outer circumference tooth
12 toothed yoke
14 toothed permanent magnet
15, 16 magnetic wall
19, 20 oil
21 piston
23 exhaust port
24 nonmagnetic substance mobile part

1. A linear motor which comprises an armature part including a coil, a field magnet part including a permanent magnet or an electromagnet, and a yoke part, in which the armature part is distributed in the field magnet part to excite the coil in the armature part, and which gives either the armature part or the field magnet part a rectilinear motion,
wherein the armature part has a molded body in which the coil is covered with a magnetic substance, or has a structure in which a wall is formed on at least one of the internal circumference and the outer circumference of the coil with a magnetic cylindrical body.

2. The linear motor according to claim 1, wherein at least one of the internal circumference and the outer circumference of the armature part has a concavo-convex shape, and a part facing the armature part has a concavo-convex shape which follows the concavo-convex shape of the armature part via a gap.

3. The linear motor according to claim 1, wherein the permanent magnet or the electromagnet in the field magnet part is divided into p numbers of pieces, and the magnetic substance or the magnetic cylindrical body in the armature part is similarly divided into p numbers of pieces, wherein p represents a positive integer of two or more.

4. The linear motor according to claim 2, wherein the permanent magnet or the electromagnet in the field magnet part is divided into p numbers of pieces, and the magnetic substance or the magnetic cylindrical body in the armature part is similarly divided into p numbers of pieces, wherein p represents a positive integer of two or more.

5. A linear dynamo which comprises an armature part including a coil, a field magnet part including a permanent magnet or an electromagnet, and a yoke part, in which an electromotive force is generated in the coil of the armature part by a rectilinear repetition movement in at least one of the armature part and the field magnet part by giving an external force,
wherein the armature part has a molded body in which the coil is covered with a magnetic substance, or has a structure in which a wall is formed on at least one of the internal circumference and the outer circumference of the coil with a magnetic cylindrical body.

6. The linear dynamo according to claim 5, wherein at least one of the internal circumference and the outer circumference of the armature part has a concavo-convex shape, and a part facing the armature part has a concavo-convex shape which follows the concavo-convex shape of the armature part via a gap.

7. The linear dynamo according to claim 5, wherein the permanent magnet or the electromagnet in the field magnet part is divided into p numbers of pieces, and the magnetic substance or the magnetic cylindrical body in the armature part is similarly divided into p numbers of pieces, wherein p represents a positive integer of two or more.

8. The linear dynamo according to claim 6, wherein the permanent magnet or the electromagnet in the field magnet part is divided into p numbers of pieces, and the magnetic substance or the magnetic cylindrical body in the armature part is similarly divided into p numbers of pieces, wherein p represents a positive integer of two or more.

9. A reciprocation-type compressor drive system which is powered by the linear motor according to claim 1.

10. A charge system in which the linear dynamo according to claim 5 is installed in a four-wheeled vehicle or two-wheeled motorcycle so as to be positioned coaxially with or in parallel with a shock absorber of the vehicle or the motorcycle, and the linear dynamo generates electricity by utilizing up-and-down jolting of the body of the vehicle or the motorcycle, and the electricity generated is charged into a battery.

11. A charge system in which the linear dynamo according to claim 5 is installed in a four-wheeled vehicle, a two-wheeled motorcycle, or a power-assisted bicycle so as to be positioned coaxially with or in parallel with a coil spring of a seat or a saddle of the vehicle, the motorcycle or the bicycle, and the linear dynamo generates electricity by utilizing up-and-down jolting of the body of the vehicle, the motorcycle or the bicycle, and the electricity generated is charged into a battery.

12. A charge system in which the linear dynamo according to claim 5 is installed on an internal combustion engine, and the linear dynamo generates electricity by utilizing vibration energy of the engine, and the electricity generated is charged into a battery.

13. A charge system in which the linear dynamo according to claim 5 is installed in a ship or a float, and the linear dynamo generates electricity by utilizing kinetic energy due to dipping and heaving or swaying of the ship or the float, and the electricity generated is charged into a battery.
